(19) United States
(12) Patent Application Publication
(10) Pub. No.: US 2023/0289484 A1
(43) Pub. Date: Sep. 14, 2023

(54) INFORMATION PROCESSING APPARATUS AND CONTROL METHOD

(71) Applicant: Lenovo (Singapore) Pte. Ltd., Singapore (SG)

(72) Inventor: Masashi Nishio, Kanagawa (JP)

(73) Assignee: Lenovo (Singapore) Pte. Ltd., Singapore (SG)

(21) Appl. No.: 18/174,313

(22) Filed: Feb. 24, 2023

(30) Foreign Application Priority Data
Mar. 14, 2022 (JP) 2022-039625

(51) Int. Cl. G06F 21/84; G01S 13/08; G01S 13/86; G06F 21/31

(52) U.S. Cl. CPC G06F 21/84; G01S 13/08; G01S 13/867; G06F 21/31

(57) ABSTRACT

An information processing apparatus includes: a memory which temporarily stores a program of an Operating System (OS); a first processor which executes processing based on the program of the OS stored in the memory; a display unit which displays display information according to processing based on the program of the OS; a sensor for detecting distance to and position of one or more persons present within a predetermined range in a direction to face a display surface of the display unit; and a second processor which acquires detection results of the sensor to execute processing based on the acquired detection results. The first processor performs user authentication processing for determining whether or not to allow use of at least some of functions of the OS.

### CROSS-REFERENCE TO RELATED APPLICATIONS

This application claims priority to Japanese Patent Application No. 2022-39625 filed on Mar. 14, 2022, the contents of which are hereby incorporated herein by reference in their entirety.

### TECHNICAL FIELD

The present invention relates to an information processing apparatus and a control method.

### BACKGROUND

There is an information processing apparatus which makes a transition to a usable state when a person approaches or to a standby state in which functions except some of the functions are stopped when the person leaves. For example, in Japanese Unexamined Patent Application Publication No. 2016-148895, an infrared sensor is used to detect whether a person is approaching or a person goes away.

Further, in recent years, there has also been an information processing apparatus equipped with a radar to detect a person. For example, the distance to and position of a person in front of the information processing apparatus can be detected using a dual-channel radar sensor, which can also detect two or more persons.

When two or more persons are detectable, the presence or absence of a person(s) other than a user around the user is also detectable. This is also possible to detect peeping (Shoulder surfing) by a person other than the user, but when two or more persons are detected, it may not be able to determine correctly which person is the user.

### SUMMARY

One or more embodiments of the present invention provide an information processing apparatus and a control method capable of detecting a user properly even when two or more persons are detected forward.

An information processing apparatus according to one or more embodiments of the present invention includes: a memory which temporarily stores a program of an OS (Operating System); a first processor which executes processing based on the program of the OS stored in the memory; a display unit which displays display information according to processing based on the program of the OS; a sensor for detecting distance to and position of one or more persons present within a predetermined range in a direction to face a display surface of the display unit; and a second processor which acquires detection results of the sensor to execute processing based on the acquired detection results, wherein the first processor performs user authentication processing for determining whether or not to allow use of at least some of functions of the OS, and the second processor performs registration processing to register the position of a person closest in distance among persons detected using the sensor at timing when the use is determined to be allowed by the user authentication processing.

The above information processing apparatus may also be such that the second processor performs tracking processing to track the position of the person registered by the registration processing.

The above information processing apparatus may further be such that when two or more persons are detected using the sensor, the second processor determines the person registered by the registration processing to be a user, and a person(s) other than the registered person is determined not to be the user.

Further, the above information processing apparatus may be such that the second processor detects peeping by a person other than the user by detecting the person other than the person registered by the registration processing using the sensor.

Further, the above information processing apparatus may be such that, in a case where the person registered by the registration processing is no longer detected within the predetermined range, the second processor determines that the user has left even when a person(s) other than the registered person is detected within the predetermined range.

Further, the above information processing apparatus may be such that when determining that the user has left, the second processor limits use of at least some of functions of the OS.

Further, the above information processing apparatus may be such that the sensor is a radar sensor for detecting the distance to and position of an object to be measured and present within the predetermined range.

Further, the above information processing apparatus may be such that the sensor is a camera for detecting the distance to and position of an object to be measured and present within the predetermined range.

Further, a control method according to one or more embodiments of the present invention is a control method for an information processing apparatus including: a memory which temporarily stores a program of an OS (Operating System); a first processor which executes processing based on the program of the OS stored in the memory; a display unit which displays display information according to processing based on the program of the OS; a sensor for detecting the distance to and position of one or more persons present within a predetermined range in a direction to face a display surface of the display unit; and a second processor which executes processing based on the detection results of the sensor, the control method including: a step of causing the first processor to perform user authentication processing for determining whether or not to allow use of at least some of functions of the OS; and a step of causing the second processor to register the position of a person closest in distance among persons detected using the sensor at the timing when the use is determined to be allowed by the user authentication processing.

The above embodiments of the present invention can detect a user properly even when two or more persons are detected in front of the information processing apparatus.

### BRIEF DESCRIPTION OF THE DRAWINGS

FIGS. 1A-1C are diagrams for describing an outline of HPD processing of an information processing apparatus according to one or more embodiments.

FIG. 2 is a diagram illustrating an example of a person detection range of the information processing apparatus according to one or more embodiments.

FIG. 3 is a diagram illustrating an outline of user detection processing of the information processing apparatus according to one or more embodiments.

FIG. 4 is a perspective view illustrating an appearance configuration example of the information processing apparatus according to one or more embodiments.

FIG. 5 is a schematic block diagram illustrating an example of the hardware configuration of the information processing apparatus according to one or more embodiments.

FIG. 6 is a schematic block diagram illustrating an example of the functional configuration of the information processing apparatus according to one or more embodiments.

FIG. 7 is a diagram illustrating a detection example of peeping by a person other than a user according to one or more embodiments.

FIG. 8 is a diagram illustrating a detection example of the leave of the user according to one or more embodiments.

FIG. 9 is a flowchart illustrating an example of user registration processing according to one or more embodiments.

FIG. 10 is a flowchart illustrating an example of HPD processing in a tracking mode according to one or more embodiments.

### DETAILED DESCRIPTION

Embodiments of the present invention will be described below with reference to the accompanying drawings.

[Outline]

First, the outline of an information processing apparatus 1 according to one or more embodiments will be described. The information processing apparatus 1 according to one or more embodiments is, for example, a laptop PC (Personal Computer). Note that the information processing apparatus 1 may also be any other form of information processing apparatus such as a desktop PC, a tablet terminal, or a smartphone.

The information processing apparatus 1 can make a transition at least between a normal operating state (power-on state) and a standby state as system operating states. The normal operating state is an operating state capable of executing processing without being particularly limited, which corresponds, for example, to S0 state defined in the ACPI (Advanced Configuration and Power Interface) specification. The standby state is a state in which at least part of system processing is limited. For example, the standby state may be the standby state or a sleep state, modern standby in Windows (registered trademark), a state corresponding to S3 state (sleep state) defined in the ACPI specification, or the like. Further, a state in which at least the display of a display unit appears to be OFF (screen OFF), or a screen lock state may be included as the standby state. The screen lock is a state in which an image preset to make a content being processed invisible (for example, an image for the screen lock) is displayed on the display unit, that is, an unusable state until the lock is released (for example, until the user is authenticated).

In the following, a transition of the system operating state from the standby state to the normal operating state may also be called “boot.” In the standby state, since the activation level is generally lower than that in the normal operating state, the boot of the system of the information processing apparatus 1 leads to the activation of the operation of the system in the information processing apparatus 1.

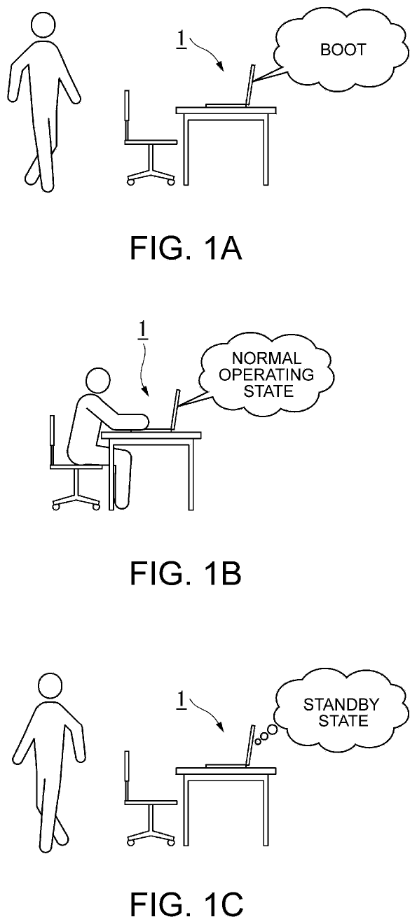

FIGS. 1A-1C are diagrams for describing the outline of HPD processing of the information processing apparatus 1 according to one or more embodiments. The information processing apparatus 1 detects a person (i.e., a user) present in the neighborhood of the information processing apparatus 1. This processing to detect the presence of a person is called HPD (Human Presence Detection) processing. The information processing apparatus 1 detects the presence or absence of a person by the HPD processing to control the operating state of the system of the information processing apparatus 1 based on the detection result. For example, as illustrated in FIG. 1A, when detecting a change from a state where no person is present in front of the information processing apparatus 1 (Absence) to a state where a person is present (Presence), that is, when detecting that a person has approached the information processing apparatus 1 (Approach), the information processing apparatus 1 determines that the user has approached and automatically boots the system to make the transition to the normal operating state. Further, in a state where a person is present in front of the information processing apparatus 1 (Presence) as illustrated in FIG. 1B, the information processing apparatus 1 determines that the user is present and continues the normal operating state. Then, as illustrated in FIG. 1C, when detecting a change from the state where the person is present in front of the information processing apparatus 1 (Presence) to a state where no person is present (Absence), that is, when detecting that the person has left the information processing apparatus 1 (Leave), the information processing apparatus 1 determines that the user has left and causes the system to make the transition to the standby state.

The information processing apparatus 1 detects the presence of a person within a predetermined range in front of the information processing apparatus 1.

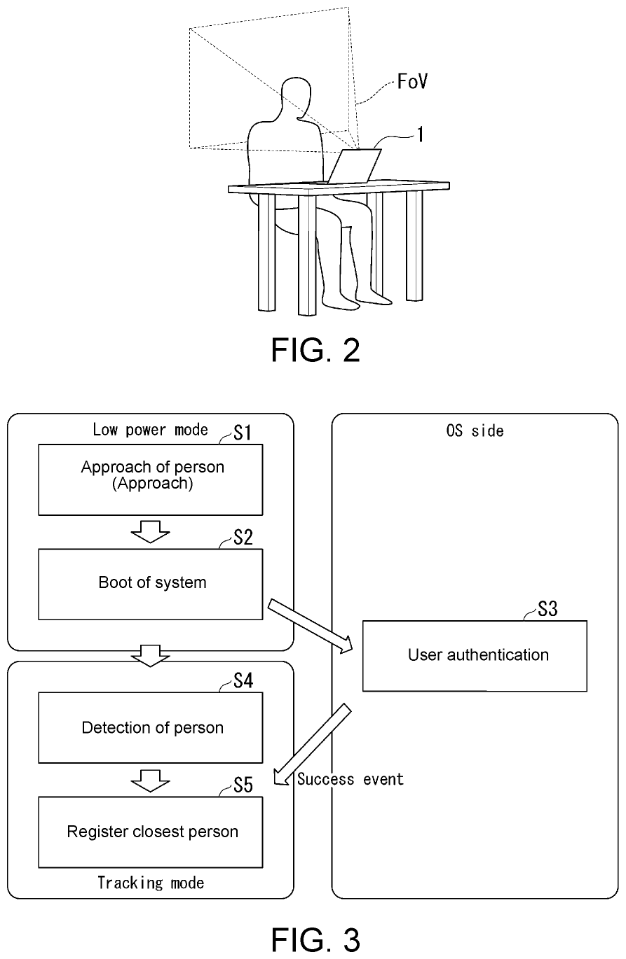

FIG. 2 is a diagram illustrating an example of a person detection range of the information processing apparatus 1 according to one or more embodiments. In the illustrated example, a detection range FoV (Field of View: detection viewing angle) in front of the information processing apparatus 1 is a person-detectable range.

As person detection methods, although various detection methods using a camera, a radar sensor, and the like can be applied, the detection methods will be described here by taking, as examples, a detection method using a camera (visible light camera) and a detection method using a radar sensor.

When the camera (visible light camera) is used, the information processing apparatus 1 detects a face area with a face captured therein from a captured image captured forward to determine whether or not a person is present in front of the information processing apparatus 1. The detection range FoV corresponds to an imaging angle of view at which the information processing apparatus 1 captures the image. For example, when the face area is detected from the captured image, the information processing apparatus 1 determines that a person is present. On the other hand, when the face area is not detected from the captured image, the information processing apparatus 1 determines that any person is not present.

When the radar sensor is used, the information processing apparatus 1 radiates radio waves forward and receives reflected waves of the radiated radio waves to detect the distance to and position (direction) of an object present in front of the information processing apparatus 1. For example, the information processing apparatus 1 determines that a person is present by detecting a moving object within the detection range FoV. The term “moving” in the phrase “moving object” is a minute movement caused by human breathing, an intentional movement of a person, or the like. On the other hand, when detecting no moving object within the detection range FoV, the information processing apparatus 1 determines that any person is not present.

Here, the person detection method using the camera (visible light camera) does not need to radiate radio waves unlike the person detection method using the radar sensor. Therefore, the person detection method using the camera (visible light camera) has the advantage of lower power consumption than the person detection method using the radar sensor. However, since the person detection method using the camera (visible light camera) determines the detection of the distance to a person based on the size of a face area or the like, it is lower in distance detection accuracy than the person detection method using the radar sensor. The person detection method using the radar sensor can accurately detect the distances to and positions of two or more persons.

Further, when determining that the user is present by detecting a person within the detection range FoV in front of the information processing apparatus 1, the information processing apparatus 1 boots the system to make the transition to the normal operating state. On the way of boot processing, the information processing apparatus 1 executes user authentication processing to authenticate whether or not the detected person is an authorized user (login authentication). The user authentication processing such as this login authentication is processing for determining whether or not to allow use of at least some of functions of an OS (Operating System). When determining that the person is the authorized user, the information processing apparatus 1 allows the use (allows the login) and continues the boot processing to make the transition to the normal operating state. On the other hand, when determining that the person is not the authorized user, the information processing apparatus 1 continues waiting for authentication without allowing the use (without allowing the login). The user authentication at boot-up is called “login authentication” below.

As user authentication methods, there are password authentication performed by the user entering a password from a keyboard or the like, face authentication to authenticate the user from a user's face image captured with the camera, fingerprint authentication to authenticate the user from the user's fingerprint, and the like. In the case of the password authentication, the information processing apparatus 1 checks a password string input from the keyboard or the like against a password string of a preregistered, authorized user to perform the user authentication processing. In the case of the face authentication, the information processing apparatus 1 checks a face image of a person captured with the camera against a face image of the preregistered, authorized user to perform the user authentication processing. In the case of the fingerprint authentication, the information processing apparatus 1 checks a fingerprint input to a fingerprint sensor or the like against a fingerprint of the preregistered, authorized user to perform the user authentication processing. Note that any method other than the above methods may also be used as the user authentication method.

Here, the information processing apparatus 1 may detect two or more persons within the detection range FoV. In this case, the information processing apparatus 1 determines that a person closest in distance to the information processing apparatus 1 is a user (main user). For example, the information processing apparatus 1 registers the person closest in distance as the user at the timing when determining that the person is the authorized user in the login authentication upon booting the system (that is, when determining to allow the use). Then, the information processing apparatus 1 tracks the position of the registered person.

FIG. 3 is a diagram illustrating an outline of user detection processing according to one or more embodiments. First, in the standby state, the information processing apparatus 1 detects a change from a state where no person is present in front of the information processing apparatus 1 to a state where a person is present, that is, the information processing apparatus 1 detects the approach of a person to the information processing apparatus 1 (Approach) (step S1). For example, when detecting the approach of a person to the information processing apparatus 1 (Approach), the detection is performed in a lower power detection mode (Low power mode) using the camera (visible light camera). The information processing apparatus 1 boots the system when detecting the approach of a person to the information processing apparatus 1 (Approach) (step S2).

When booting the system, the information processing apparatus 1 downloads the OS after BIOS processing to boot the OS. Then, during the booting of the OS, the information processing apparatus 1 executes user authentication processing to authenticate whether or not the detected person is the authorized user (login authentication) (step S3). This user authentication processing is processing executed by the OS.

Further, when the system is booted in step S2, the information processing apparatus 1 performs the detection of a person using the radar sensor (step S4). Use of the radar sensor makes it possible to detect the distances to and positions of two or more persons.

When the authorized user is determined in the user authentication processing of step S3, the information processing apparatus 1 receives, from the OS, authentication success information (Success event) indicating that the authentication is successful, and registers a person closest in distance to the information processing apparatus 1 at the timing of receiving the authentication success information. For example, the information processing apparatus 1 registers, as the user, the person closest in distance to the information processing apparatus 1 among one or more persons detected in step S4, and starts tracking of the position of the person (Tracking mode).

Thus, even when two or more persons are detected in front of the information processing apparatus 1, the information processing apparatus 1 can correctly detect the user using the information processing apparatus 1, and can perform proper processing according to the user. Further, when two or more persons are detected in front of the information processing apparatus 1, the information processing apparatus 1 determines that a person(s) other than the person registered as the user is not the user, and hence it is also possible for the information processing apparatus 1 to detect peeping (Shoulder surfing) by a person other than the user.

The configuration of the information processing apparatus 1 according to one or more embodiments will be described in detail below.

[Appearance Configuration of Information Processing Apparatus]

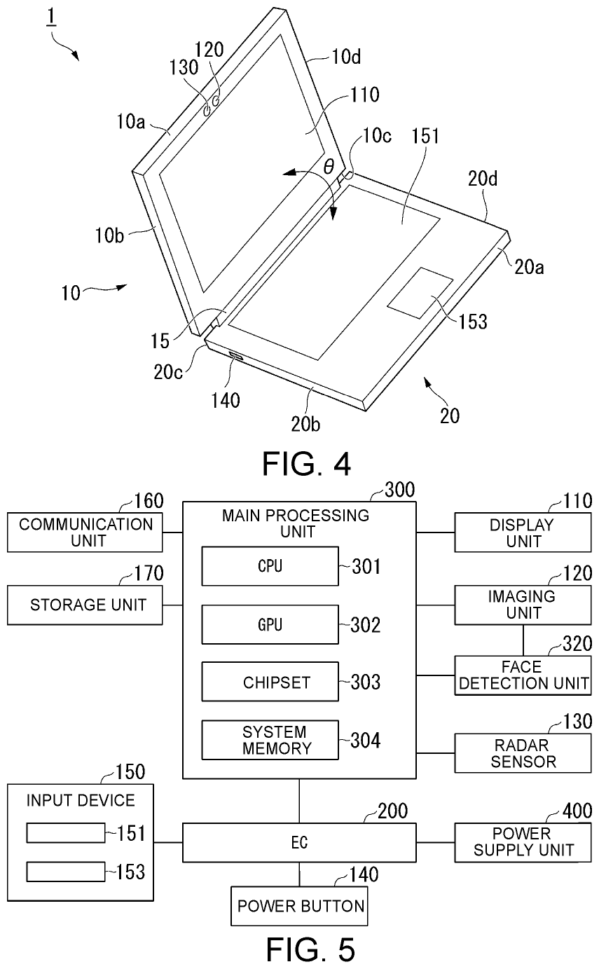

FIG. 4 is a perspective view illustrating an appearance configuration example of the information processing apparatus 1 according to one or more embodiments.

The information processing apparatus 1 includes a first chassis 10, a second chassis 20, and a hinge mechanism 15. The first chassis 10 and the second chassis 20 are coupled by using the hinge mechanism 15. The first chassis 10 is rotatable around an axis of rotation formed by the hinge mechanism 15 relative to the second chassis 20. An open angle by the rotation between the first chassis 10 and the second chassis 20 is denoted by “θ” in FIG. 4.

The first chassis 10 is also called A cover or a display chassis. The second chassis 20 is also called C cover or a system chassis. In the following description, side faces on which the hinge mechanism 15 is provided among side faces of the first chassis 10 and the second chassis 20 are referred to as side faces 10c and 20c, respectively. Among the side faces of the first chassis 10 and the second chassis 20, faces opposite to the side faces 10c and 20c are referred to as side faces 10a and 20a, respectively. In this figure, the direction from the side face 20a toward the side face 20c is referred to as “rear,” and the direction from the side face 20c to the side face 20a is referred to as “front.” The right hand and left hand in the rearward direction are referred to as “right” and “left,” respectively. Left side faces of the first chassis 10 and the second chassis 20 are referred to as side faces 10b and 20b, respectively, and right side faces thereof are referred to as side faces 10d and 20d, respectively. Further, a state where the first chassis 10 and the second chassis 20 overlap each other and are completely closed (a state of open angle θ=0°) is referred to as a “closed state.” The faces of the first chassis 10 and the second chassis 20 on the face-to-face sides in the closed state are referred to as respective “inner faces,” and the faces opposite to the inner faces are referred to as “outer faces.” Further, a state opposite to the closed state, where the first chassis 10 and the second chassis 20 are open, is referred to as an “open state.”

The appearance of the information processing apparatus 1 in FIG. 4 illustrates an example of the open state. The open state is a state where the side face 10a of the first chassis 10 and the side face 20a of the second chassis 20 are separated. In the open state, the respective inner faces of the first chassis 10 and the second chassis 20 appear. The open state is one of states when the user uses the information processing apparatus 1, and the information processing apparatus 1 is often used in a state where the open angle is typically about θ=100° to 130°. Note that the range of open angles θ to be the open state can be set arbitrarily according to the range of angles rotatable by the hinge mechanism 15 or the like.

A display unit 110 is provided on the inner face of the first chassis 10. The display unit 110 is configured to include a liquid crystal display (LCD) or an organic EL (Electro Luminescence) display, and the like. Further, an imaging unit 120 is provided in a peripheral area of the display unit 110 on the inner face of the first chassis 10. The imaging unit 120 is configured to include an image sensor for capturing a visible light image, having the functionality of the visible light camera (RGB camera) described above. For example, the imaging unit 120 is arranged on the side of the side face 10a in the peripheral area of the display unit 110. Note that the position at which the imaging unit 120 is arranged is just an example, and it may be elsewhere as long as the imaging unit 120 can face a direction (frontward) to face the inner face of the first chassis 10.

In the open state, the imaging unit 120 captures an image within a predetermined imaging range in the direction (frontward) to face the inner face of the first chassis 10. The predetermined imaging range is a range of angles of view defined by an image sensor included in the imaging unit 120 and an optical lens provided in front of the imaging surface of the image sensor. For example, the imaging unit 120 can capture an image including a person present in front of the information processing apparatus 1.

Further, a radar sensor 130 is provided in a peripheral area of the display unit 110 on the inner face of the first chassis 10. In the example illustrated in FIG. 4, the imaging unit 120 and the radar sensor 130 are arranged side by side on the side face 10a in the peripheral area of the display unit 110. However, the imaging unit 120 and the radar sensor 130 may also be arranged anywhere in the peripheral area of the display unit 110 on the inner surface of the first chassis 10, respectively. The radar sensor 130 radiates radio waves forward and receives reflected waves of the radiated radio waves to detect the distance to an object present in front of the information processing apparatus 1. For example, the radar sensor 130 detects the distance to and position of an object (for example, a person) present within the detection range FoV in the direction (frontward) to face the inner face of the first chassis 10 in the open state.

A power button 140 is provided on the side face 20b of the second chassis 20. The power button 140 is an operating element used by the user to give an instruction to power on or power off, make the transition from the standby state to the normal operating state, make the transition from the normal operating state to the standby state, and the like. Further, a keyboard 151 and a touch pad 153 are provided on the inner face of the second chassis 20 as an input device to accept user's operation input. Note that a touch sensor may also be provided as the input device instead of or in addition to the keyboard 151 and the touch pad 153, or a mouse and an external keyboard may be connected. When the touch sensor is provided, an area corresponding to the display surface of the display unit 110 may be constructed as a touch panel to accept operations. Further, a microphone used to input voice may be included in the input device.

Note that in the closed state where the first chassis 10 and the second chassis 20 are closed, the display unit 110, the imaging unit 120, and the radar sensor 130 provided on the inner face of the first chassis 10, and the keyboard 151 and the touch pad 153 provided on the inner face of the second chassis 20 are covered with each other's chassis faces, respectively, and put in a state of being disabled from fulfilling the functions.

[Hardware Configuration of Information Processing Apparatus]

FIG. 5 is a schematic block diagram illustrating an example of the hardware configuration of the information processing apparatus 1 according to one or more embodiments. In FIG. 5, components corresponding to respective units in FIG. 4 are given the same reference numerals. The information processing apparatus 1 includes the display unit 110, the imaging unit 120, the radar sensor 130, the power button 140, an input device 150, a communication unit 160, a storage unit 170, an EC (Embedded Controller) 200, a main processing unit 300, a face detection unit 320, and a power supply unit 400.

The display unit 110 displays display data (images) generated based on system processing executed by the main processing unit 300, processing of an application program running on the system processing, and the like.

The imaging unit 120 captures an image of an object within the predetermined imaging range (angle of view) in the direction (frontward) to face the inner face of the first chassis 10, and outputs the captured image to the main processing unit 300 and the face detection unit 320. As described above, the imaging unit 120 is the visible light camera (RGB camera) using visible light.

Note that the imaging unit 120 may also be an infrared camera (IR camera) to capture an image using infrared light. For example, the imaging unit 120 may be configured to include either one of the visible light camera and the infrared camera, or configured to include both of the visible light camera and the infrared camera.

The radar sensor 130 radiates radio waves forward and receives reflected waves of the radiated radio waves to detect the distance to an object (object to be measured) present in front of the information processing apparatus 1. For example, the radar sensor 130 detects the distance to and position (direction) of an object (for example, a person) present within the detection range FoV in the direction (frontward) to face the inner face of the first chassis 10.

The power button 140 outputs, to the EC 200, an operation signal according to a user's operation. The input device 150 is an input unit for accepting user input, which is configured to include, for example, the keyboard 151 and the touch pad 153. In response to accepting operations on the keyboard 151 and the touch pad 153, the input device 150 outputs, to the EC 200, operation signals indicative of operation contents, respectively.

The communication unit 160 is connected to other devices communicably through a wireless or wired communication network to transmit and receive various data. For example, the communication unit 160 is configured to include a wired LAN interface such as Ethernet (registered trademark), a wireless LAN interface such as Wi-Fi (registered trademark), and the like.

The storage unit 170 is configured to include storage media, such as an HDD (Hard Disk Drive) or an SDD (Solid State Drive), a RAM, and a ROM. The storage unit 170 stores the OS, device drivers, various programs such as applications, and various data acquired by the operation of the programs.

The power supply unit 400 supplies power to each unit according to the operating state of each unit of the information processing apparatus 1. The power supply unit 400 includes a DC (Direct Current)/DC converter. The DC/DC converter converts the voltage of DC power, supplied from an AC (Alternate Current)/DC adapter or a battery (battery pack) to a voltage required for each unit. The power with the voltage converted by the DC/DC converter is supplied to each unit through each power system. For example, the power supply unit 400 supplies power to each unit through each power system based on a control signal input from the EC 200.

The EC 200 is a microcomputer configured to include a CPU (Central Processing Unit), a RAM (Random Access Memory), a ROM (Read Only Memory), an I/O (Input/Output) logic circuit, and the like. The CPU of the EC 200 reads a control program (firmware) prestored in the own ROM, and executes the read control program to fulfill the function. The EC 200 operates independently of the main system processing unit 300 to control the operation of the main processing unit 300 and manage the operating state of the main processing unit 300. Further, the EC 200 is connected to the power button 140, the input device 150, the power supply unit 400, and the like.

For example, the EC 200 communicates with the power supply unit 400 to acquire information on a battery state (remaining battery capacity, and the like) from the power supply unit 400 and to output, to the power supply unit 400, a control signal or the like in order to control the supply of power according to the operating state of each unit of the information processing apparatus 1. Further, the EC 200 acquires operation signals from the power button 140 and the input device 150, and outputs, to the main processing unit 300, an operation signal related to processing of the main processing unit 300 among the acquired operation signals.

The main processing unit 300 is configured to include a CPU (Central Processing Unit) 301, a GPU (Graphic Processing Unit) 302, a chipset 303, and a system memory 304, where processing of various application programs is executable on the OS (Operating System) by system processing based on the OS.

The CPU 301 executes processing based on a BIOS program, processing based on the OS program, processing based on application programs running on the OS, and the like. The CPU 301 controls the operating state of the system under the control of the chipset 303. For example, the CPU 301 executes boot processing to cause the operating state of the system to make the transition from the standby state to the normal operating state. Further, the CPU 301 executes user authentication processing to authenticate whether or not a person is the authorized user during the boot processing. When the function of login authentication by face authentication is set to enabled, the CPU 301 executes user authentication processing by the face authentication in the boot processing. On the other hand, when the function of the login authentication by the face authentication is set to be disabled, the CPU 301 executes user authentication processing other than that of the face authentication (for example, password authentication) in the boot processing.

When determining that the person is the authorized user in the user authentication processing, the CPU 301 allows the user to use the information processing apparatus 1 (allows the login), and continues the boot processing to make the transition to the normal operating state. On the other hand, when determining that the person is not the authorized user in the user authentication processing, the CPU 301 continues waiting for authentication without allowing the use (without allowing the login).

The GPU 302 is connected to the display unit 110. The GPU 302 executes image processing under the control of the CPU 301 to generate display data. The GPU 302 outputs the generated display data to the display unit 110.

The chipset 303 has a function as a memory controller, a function as an I/O controller, and the like. For example, the chipset 303 controls reading data from and writing data to the system memory 304, the storage unit 170, and the like by the CPU 301 and the GPU 302. Further, the chipset 303 controls input/output of data from the communication unit 160, the display unit 110, and the EC 200. Further, the chipset 303 has a function as a sensor hub. For example, the chipset 303 acquires the detection result by face detection processing to be acquired from the face detection unit 320, the authentication result by the face authentication processing, and the like. Further, the chipset 303 acquires, from the radar sensor 130, the detection results of the distance to and position (direction) of an object (for example, a person) present within the detection range FoV. For example, the chipset 303 executes HPD processing based on information acquired from the face detection unit 320 or the radar sensor 130.

The system memory 304 is used as a reading area of a program executed by the CPU 301 and a working area to write processed data. Further, the system memory 304 temporarily stores image data of a captured image captured by the imaging unit 120.

Note that the CPU 301, the GPU 302, and the chipset 303 may also be integrated as one processor, or some or all of them may be configured as individual processors. For example, in the normal operating state, the CPU 301, the GPU 302, and the chipset 303 are all working, but in the standby state, only at least some of the functions of the chipset 303 are working. In the standby state, at least only functions required for HPD processing upon booting are working.

The face detection unit 320 is configured to include a processor for processing image data of a captured image captured by the imaging unit 120. The face detection unit 320 acquires the image data of the captured image captured by the imaging unit 120, and temporarily stores the acquired image data in a memory. The memory in which the image data is stored may be the system memory 304, or a memory connected to the above processor included in the face detection unit 320.

For example, face detection unit 320 processes the image data of the captured image acquired from the imaging unit 120 to perform face detection processing to detect a face area from the captured image, face authentication processing to authenticate the detected face, and the like. The face detection unit 320 transmits, to the chipset 303 of the main processing unit 300, the detection result by the face detection processing, the authentication result by the face authentication processing, and the like.

Note that this face detection unit 320 is also working in the standby state. As described above, in the standby state, the face detection unit 320 acquires image data of a captured image captured with the RGB camera of the imaging unit 120 to detect the face area. The use of the RGB camera without using the IR camera can reduce power consumption in the standby state.

[Functional Configuration of Information Processing Apparatus]

Next, a functional configuration of HPD processing by the information processing apparatus 1 will be described in detail.

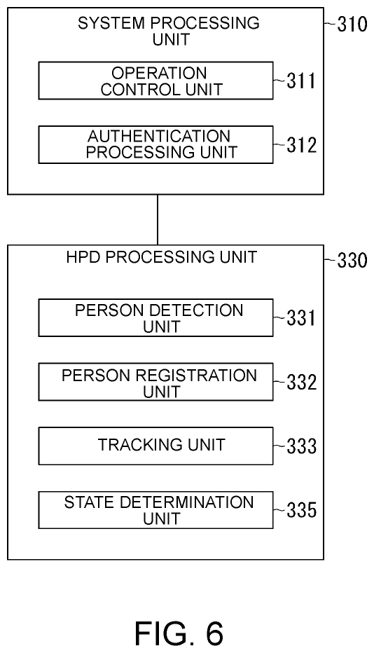

FIG. 6 is a schematic block diagram illustrating an example of the functional configuration of the information processing apparatus 1 according to one or more embodiments. The information processing apparatus 1 includes a system processing unit 310 and an HPD processing unit 330.

The system processing unit 310 is a functional component implemented by the CPU 301 executing processing by the BIOS and the OS. For example, the system processing unit 310 includes an operation processing unit 311 and an authentication processing unit 312 as functional components by the OS processing.

The operation processing unit 311 controls the operating state of the system. For example, the operation processing unit 311 controls the operating state of the system to the normal operating state, the standby state, or the like under the control of the HPD processing unit 330. As an example, when acquiring a boot instruction from the HPD processing unit 330, the operation processing unit 311 executes boot processing to cause the operating state of the system to make the transition from the standby state to the normal operating state. Further, when acquiring, from the HPD processing unit 330, an instruction to cause the operating state of the system to make the transition to the standby state, the operation processing unit 311 causes the operating state of the system to make the transition from the normal operating state to the standby state.

The authentication processing unit 312 executes user authentication processing to authenticate whether or not the person is the authorized user (login authentication) during the boot processing. When the function of the login authentication by the face authentication is set to enabled, the authentication processing unit 312 executes user authentication processing by the face authentication in the boot processing. On the other hand, when the function of the login authentication by the face authentication is set to disabled, the authentication processing unit 312 executes user authentication processing by an authentication method other than the face authentication (for example, password authentication) in the boot processing. When determining that the person is the authorized user in the user authentication processing, the authentication processing unit 312 transmits, to the HPD processing unit 330, the authentication success information (Success event) indicating that the authentication is successful.

The HPD processing unit 330 is a functional component to execute HPD processing by processing of the chipset 303. For example, the HPD processing unit 330 includes a person detection unit 331, a person registration unit 332, a tracking unit 333, and a state determination unit 335.

The person detection unit 331 detects a person present in front of the information processing apparatus 1 using the imaging unit 120 or the radar sensor 130. For example, the person detection unit 331 detects the presence or absence of a person within the detection range FoV based on the whether or not the face area is detected by the face detection unit 320 from the captured image captured by using the imaging unit 120. Further, based on the detection results of the radar sensor 130, the person detection unit 331 detects the distances to and positions of one or more persons present within the detection range FoV.

When receiving the authentication success information as a result of the user authentication processing by the authentication processing unit 312, the person registration unit 332 registers a person closest in distance among one or more persons detected by the person detection unit 331 at the timing of receiving the authentication success information. In other words, the person registration unit 332 registers the person closest in distance among persons detected by using the radar sensor 130 at the timing when the authentication by the user authentication processing is successful. For example, the person registration unit 332 stores information indicative of the position of the person closest in distance in a memory (not illustrated) inside the chipset 303, the system memory 304, or the like.

Based on the detection results of the radar sensor 130, the tracking unit 333 executes tracking processing to track the position of the person registered by the person registration unit 332 as the position of the user.

When the person detection unit 331 detects a person within detection range FoV based on the detection result of the face detection unit 320 in the standby state, the state determination unit 335 determines that the user is approaching the information processing apparatus 1, and gives the boot instruction to the system processing unit 310 to execute the boot processing.

Further, when two or more persons are detected within the detection range FoV, the state determination unit 335 determines that the person registered by the person registration unit 332 is the user, and determines that a person(s) other than the registered person is not the user. In other words, in the normal operating state, the state determination unit 335 determines the person registered by the person registration unit 33 as a person to be subjected to HPD processing as the user.

For example, the state determination unit 335 may also detect a person(s) other than the person (user) registered by the person registration unit 332 to detect peeping (Shoulder surfing) by any person other than the user.

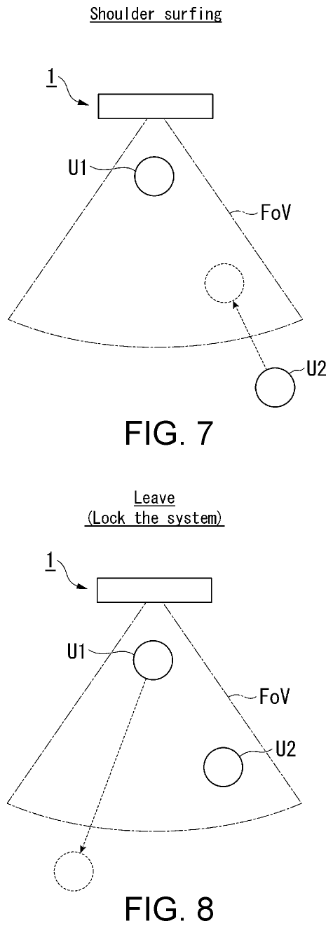

FIG. 7 is a diagram illustrating a detection example of peeping (Shoulder surfing) by a person other than the user. In FIG. 7, the information processing apparatus 1 is in the normal operating state, and user U1 (closest person) is being detected within the detection range FoV. Here, it is assumed that person U2 present out of the detection range FoV comes close to the information processing apparatus 1 and enters the detection range FoV. In this case, the person U2 is farther than the user U1. Therefore, the state determination unit 335 determines that the person U2 is a person other than the user, and detects peeping (Shoulder surfing) by the person U2 other than the user.

Note that in the example illustrated in FIG. 7, the example of detecting peeping by the person U2 other than the user U1 when the person U2 present out of the detection range FoV comes close to the information processing apparatus 1 and enters the detection range FoV is described. Likewise, when any person other than the user U1 is present within the detection range FoV from the beginning (for example, from the boot-up), peeping by the person other than the user U1 may also be detected.

Further, in a case where the person (user) registered by the person registration unit 332 is no longer detected within the detection range FoV, the state determination unit 335 determines that the user has left even when any person other than the registered person (user) is detected within the detection range FoV.

FIG. 8 is a diagram illustrating a detection example of the leave of the user. In FIG. 8, the information processing apparatus 1 is in the normal operating state, and the user U1 (closest person) registered by the person registration unit 332 and the person U2 other than the user U1 are being detected within the detection range FoV. Assuming here that the user U1 moves out of the detection range FoV, it is understood that the user U1 moves out of the detection range FoV by the tracking unit 333 tracking the movement of the user U1. In the case where the user U1 is no longer detected within the detection range FoV, the state determination unit 335 determines that the user has left (Leave) even when the person U2 other than the user U1 is detected within the detection range FoV. When determining that the user has left the information processing apparatus 1, the state determination unit 335 transmits, to the system processing unit 310, an instruction to cause the operating state of the system to make the transition from the normal operating state to the standby state. Thus, the system processing unit 310 causes the operating state of the system to make the transition from the normal operating state to the standby state so as to lock the system in order to disable the use of the system.

In FIG. 8, when the person U2 moves out of the detection range FoV and the user U1 is staying within the detection range FoV, the state determination unit 335 determines that the user is present in front of the information processing apparatus 1 (Presence).

[Operation of User Registration Processing in HPD Processing]

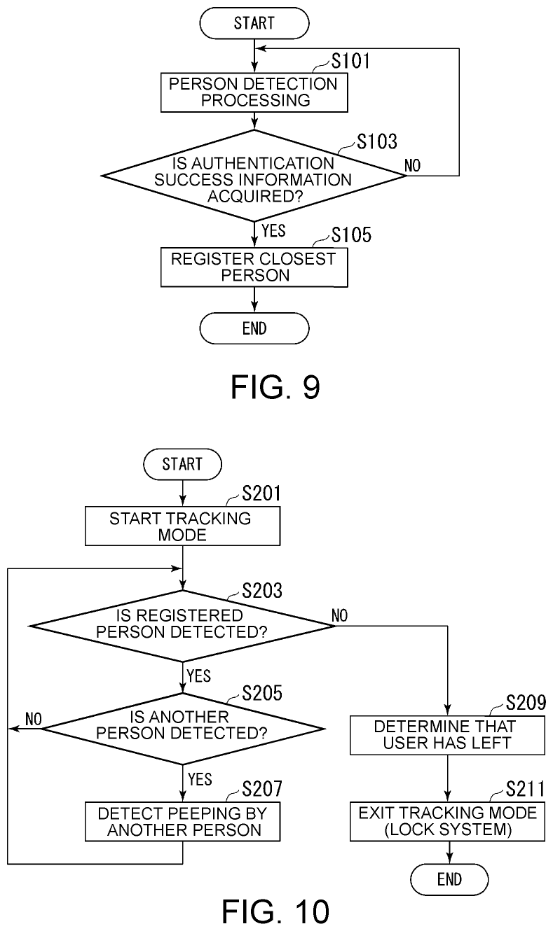

Referring next to FIG. 9, the operation of user registration processing in which the information processing apparatus 1 registers the closest person in the HPD processing as the user will be described.

FIG. 9 is a flowchart illustrating an example of user registration processing according to one or more embodiments. Here, it is assumed that the information processing apparatus 1 is placed on a desk or the like in the open state. Further, for example, the user registration processing illustrated in FIG. 9 is performed upon login authentication at the time of booting the system, but the user registration processing may also be performed upon authentication processing other than the login authentication after booting the system such as user authentication processing upon access to data protected by a password.

(Step S101) The HPD processing unit 330 uses the radar sensor 130 to detect the distance to and position of a person present within the detection range FoV in front of the information processing apparatus 1. Then, the HPD processing unit 330 proceeds to a process in step S103.

(Step S103) The HPD processing unit 330 determines whether or not authentication success information indicating that the authentication is successful in the user authentication processing is acquired from the system processing unit 310. When determining that the authentication success information is not acquired (NO), the HPD processing unit 330 returns to the process in step S101 to continue the detection of a person(s). On the other hand, when determining that the authentication success information is acquired (YES), the HPD processing unit 330 proceeds to a process in step S105.

(Step S105) The HPD processing unit 330 registers, as the position of the user, the position of a person closest in distance among persons detected within the detection range FoV, and ends the user registration processing.

[Operation of HPD Processing in Tracking Mode]

Referring next to FIG. 10, the operation of HPD processing in the tracking mode to track, as the position of the use, the position of a person registered by the user registration processing described above will be described.

FIG. 10 is a flowchart illustrating an example of HPD processing in the tracking mode according to one or more embodiments. Here, it is assumed that the information processing apparatus 1 is placed on the desk or the like in the open state like in the case of the processing illustrated in FIG. 9. Further, the information processing apparatus 1 is in a state that has transitioned to the normal operating state after the end of the user registration processing illustrated in FIG. 9.

(Step S201) When the position of the closest person (user) is registered by the user registration processing illustrated in FIG. 9, the HPD processing unit 330 starts the tracking mode. Then, the HPD processing unit 330 proceeds to a process in step S203.

(Step S203) The HPD processing unit 330 tracks the position of the person (user) registered by the user registration processing and determines whether or not the registered person (user) is detected within the detection range FoV. When determining that the registered person (user) is detected within the detection range FoV (YES), the HPD processing unit 330 proceeds to a process in step S205. On the other hand, when determining that the registered person (user) is not detected within the detection range FoV (NO), the HPD processing unit 330 proceeds to a process in step S209.

(Step S205) When determining in step S203 that the registered person (user) is detected within the detection range FoV, the HPD processing unit 330 determines whether another person (a person other than the registered person (user)) is detected. When determining that another person is not detected (NO), the HPD processing unit 330 returns to the process in step S203. On the other hand, when determining that another person is detected (YES), the HPD processing unit 330 proceeds to a process in step S207.

(Step S207) the HPD processing unit 330 detects peeping (Shoulder surfing) by another person other than the user. Then, the HPD processing unit 330 returns to the process in step S203.

(Step S209) When determining in step S203 that the registered person (user) is not detected within the detection range FoV, the HPD processing unit 330 determines that the user has left the information processing apparatus 1. Then, the HPD processing unit 330 proceeds to a process in step S211.

(Step S211) The HPD processing unit 330 exits the tracking mode. Further, as a result of determining that the user has left, the HPD processing unit 330 transmits, to the system processing unit 310, an instruction to cause the operating state of the system to make the transition from the normal operating state to the standby state. Thus, the system processing unit 310 causes the operating state of the system to make the transition from the normal operating state to the standby state so as to lock the system in order to disable the use of the system.

### SUMMARY

As described above, the information processing apparatus 1 according to one or more embodiments includes the system memory 304 (an example of a memory) which temporarily stores an OS program, and the CPU 301 (an example of a first processor) which executes processing based on the OS program stored in the system memory 304. Further, the information processing apparatus 1 includes the display unit 110 which displays display information according to the processing based on the OS program, the radar sensor 130 (an example of a sensor) for detecting the distance to and position of one or more persons present within the detection range FoV (an example of a predetermined range) in a direction to face a display surface of the display unit (i.e., in front of the information processing apparatus 1), and the chipset 303 (an example of a second processor) which acquires the detection results of the radar sensor 130 to execute processing based on the acquired detection results. The CPU 301 performs user authentication processing to determine whether or not to allow the use of at least some of functions of the OS. The chipset 303 performs user registration processing (an example of registration processing) to register a person closest in distance among persons detected using the radar sensor 130 at the timing when the use is determined to be allowed by the user authentication processing (at the timing of authentication success). For example, the chipset 303 registers, as the position of the user, the position of the person closest in distance.

Thus, since the information processing apparatus 1 registers the position of the person closest in distance at the timing when the authentication success is determined by the user authentication processing, the user can be detected properly even when two or more persons are detected in front of the information processing apparatus 1. For example, even when the authentication method is any of face authentication, password authentication, fingerprint authentication, and the like, since the user is required to perform an operation in close proximity to the information processing apparatus 1, and the success of the authentication guarantees that the user is the authorized user, the information processing apparatus 1 can detect the user properly.

Further, the chipset 303 performs tracking processing to track the position of the person registered by the registration processing mentioned above.

Thus, the information processing apparatus 1 can continuously detect the user detected from among the two or more persons present in front of the information processing apparatus 1 even when the user or the person(s) other than the user moves after that.

Further, when the two or more persons are detected by using the radar sensor 130, the chipset 303 determines the person registered by the user registration processing to be the user, and determines the person(s) other than the registered person not to be the user.

Thus, the information processing apparatus 1 can discriminate between the user and the person(s) other than the user from among the two or more persons present in front of the information processing apparatus 1.

Further, the chipset 303 detects peeping by a person other than the user by detecting the person other than the person registered by the user registration processing using the radar sensor 130.

Thus, since the information processing apparatus 1 can detect peeping by the person other than the user, the information processing apparatus 1 can warn the user.

Further, in a case where the person (user) registered by the user registration processing is no longer detected within the detection range FoV, the chipset 303 determines that the user has left even when any person other than the registered person (user) is detected within the detection range FoV.

Thus, the information processing apparatus 1 can properly detect the leave of the user even if two or more persons are present in front of the information processing apparatus 1.

Further, when determining that the user has left, the chipset 303 limits use of at least some of the functions of the OS.

Thus, since the information processing apparatus 1 can detect the leave of the user properly and limit the use when the user has left, the information processing apparatus 1 is highly secured. Further, since any person other than the user is suppressed from being erroneously determined to be the user, the information processing apparatus 1 is convenient without limiting the use by the leave of any person other than the user.

Further, since the information processing apparatus 1 detects the distance to and position of an object (an object to be measured) present within the detection range FoV, for example, using the radar sensor 130, the distance to and position of a person present within the detection range FoV can be detected accurately.

Note that the information processing apparatus 1 may also use the imaging unit 120 (for example, visible light camera) instead of the radar sensor 130 to detect the distance to and position of an object (object to be measured) present within the detection range FoV.

In this case, the information processing apparatus 1 is less accurate in the detection of the distance and position than in the case of using the radar sensor 130, but it is low power consumption and can be applied to any information processing apparatus not equipped with the radar sensor 130.

Further, a control method for the information processing apparatus 1 according to one or more embodiments includes: a step of causing the CPU 301 (the example of the first processor) to perform user authentication processing for determining whether or not to allow use of at least some of functions of the OS; a step of causing the chipset 303 (the example of the second processor) to use the radar sensor 130 (the example of the sensor) to detect the distance to and position of one or more persons present within the detection range FoV (the example of the predetermined range) in a direction to face a display surface of the display unit 110 (that is, in front of the information processing apparatus 1); and a step of causing the chipset 303 (the example of the second processor) to register the position of a person closest in distance among persons detected using the radar sensor 130 at the timing when the use is determined to be allowed (authentication success) by the above user authentication processing.

Thus, since the information processing apparatus 1 registers the position of the person closest in distance at the timing when the authentication success is determined by the user authentication processing, the user can be detected properly even when two or more persons are detected in front of the information processing apparatus 1. For example, even when the authentication method is any of face authentication, password authentication, fingerprint authentication, and the like, since the user is required to perform an operation in close proximity to the information processing apparatus 1, and the success of the authentication guarantees that the user is the authorized user, the information processing apparatus 1 can detect the user properly.

While embodiments of this invention have been described in detail above with reference to the accompanying drawings, the specific components are not limited to those in the above-described embodiments, and design changes are included without departing from the scope of this invention. For example, the respective components in the embodiments described above can be combined arbitrarily.

Further, in the aforementioned embodiments, the configuration example in which the imaging unit 120 and the radar sensor 130 are built in the information processing apparatus 1 is described, but the present invention is not limited to this example. For example, the imaging unit 120 or the radar sensor 130 does not have to be built in the information processing apparatus 1, which may also be attachable to the information processing apparatus 1 (for example, onto any of the side faces 10a, 10b, 10c, and the like) and communicably connected to the information processing apparatus 1 wirelessly or by wire as an external accessory of the information processing apparatus 1.

Further, in the aforementioned embodiments, the example of using the detection method using the radar sensor 130 as the person detection method upon performing the user registration processing is described, but the detection may also be done by using the imaging unit 120 (visible light camera) instead of the radar sensor 130. Further, in the aforementioned embodiments, the example of using the imaging unit 120 (visible light camera) and the radar sensor 130 as the person detection method is described, but the present invention is not limited to this example. For example, any other sensor such as a stereo camera, an infrared camera (IR camera), an infrared proximity sensor, an ultrasonic sensor, or a LiDAR (Light Detection And Ranging) can be used instead of or in addition to the imaging unit 120 (visible light camera) or the radar sensor 130. For example, the infrared proximity sensor is a sensor configured to include a light-emitting part for emitting infrared light and a light-receiving part for receiving reflected light which is the infrared light returned after emitted and reflected on the surface of an object. Note that the infrared proximity sensor may be a sensor using infrared light emitted by a light-emitting diode, or a sensor using an infrared laser emitting a light beam narrower in wavelength band than the infrared light emitted by the light-emitting diode. Further, the above-mentioned various sensors may not be built in the information processing apparatus 1, which may also be attachable to the information processing apparatus 1 (for example, onto any of the side faces 10a, 10b, 10c, and the like) and communicably connected to the information processing apparatus 1 wirelessly or by wire as external accessories of the information processing apparatus 1. Further, the imaging unit 120 and the radar sensor 130 (or any other sensor(s)) may be integrally constructed. Further, when detecting a person using the imaging unit 120 (visible light camera), the information processing apparatus 1 may also detect an area in which at least part of the body, not just a face, is captured to detect the person.

Further, the CPU 301 (the example of the first processor) and the chipset 303 (the example of the second processor) may be configured as individual processors, or may be integrated as one processor.

Further, in the aforementioned embodiments, the example in which the face detection unit 320 is provided separately from the chipset 303 is illustrated, but some or all of the functions of the face detection unit 320 may be provided by the chipset 303, or provided by a processor integrated with the chipset 303. Further, some or all of the functions of the face detection unit 320 may be provided by the EC 200. Further, in the aforementioned embodiments, the example in which the chipset 303 includes the HPD processing unit 330 is illustrated, but some or all of the functions of the HPD processing unit 330 may be provided by the EC 200.

Further, a hibernation state, a power-off state, and the like may be included as the standby state described above. The hibernation state corresponds, for example, to S4 state defined in the ACPI specification. The power-off state corresponds, for example, to S5 state (shutdown state) defined in the ACPI specification. Note that the standby state, the sleep state, the hibernation state, the power-off state, and the like as the standby state are states lower in power consumption than the normal operating state (states of reducing power consumption).

Note that the information processing apparatus 1 described above has a computer system therein. Then, a program for implementing the function of each component included in the information processing apparatus 1 described above may be recorded on a computer-readable recording medium so that the program recorded on this recording medium is read into the computer system and executed to perform processing in each component included in the information processing apparatus 1 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a storage medium such as a flexible disk, a magneto-optical disk, a portable medium like a flash ROM or a CD-ROM, or a hard disk incorporated in the computer system. The recording medium with the program stored thereon may be a non-transitory recording medium such as the CD-ROM.

Further, a recording medium internally or externally provided to be accessible from a delivery server for delivering the program is included as the recording medium. Note that the program may be divided into plural pieces, downloaded at different timings, respectively, and then united in each component included in the information processing apparatus 1, or delivery servers for delivering respective divided pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called differential file (differential program) capable of implementing the above-described functions in combination with a program(s) already recorded in the computer system.

Further, some or all of the functions of the information processing apparatus 1 in the above-described embodiments may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

Further, the information processing apparatus 1 in the aforementioned embodiments is not limited to the PC, the tablet terminal, the smartphone, or the like, which may also be a game machine, a multi-media terminal, or the like.

### DESCRIPTION OF SYMBOLS

1 information processing apparatus
10 first chassis
20 second chassis
15 hinge mechanism
110 display unit
120 imaging unit
130 radar sensor
140 power button
150 input device
151 keyboard
153 touch pad
160 communication unit
170 storage unit
200 EC
300 main processing unit
301 CPU
302 GPU
303 chipset
304 system memory
310 system processing unit
311 operation processing unit
312 authentication processing unit
320 face detection unit
330 HPD processing unit
331 person detection unit
332 person registration unit
333 tracking unit
335 state determination unit
400 power supply unit

What is claimed is:

1. An information processing apparatus comprising:
a memory which temporarily stores a program of an Operating System (OS);
a first processor which executes processing based on the program of the OS stored in the memory;
a display unit which displays display information according to processing based on the program of the OS;
a sensor for detecting distance to and position of one or more persons present within a predetermined range in a direction to face a display surface of the display unit; and
a second processor which acquires detection results of the sensor to execute processing based on the acquired detection results, wherein
the first processor performs user authentication processing for determining whether or not to allow use of at least some of functions of the OS, and
the second processor performs registration processing to register the position of a person closest in distance among persons detected using the sensor at the timing when the use is determined to be allowed by the user authentication processing.

2. The information processing apparatus according to claim 1, wherein the second processor performs tracking processing to track the position of the person registered by the registration processing.

3. The information processing apparatus according to claim 1, wherein when two or more persons are detected using the sensor, the second processor determines the person registered by the registration processing to be a user, and a person(s) other than the registered person is determined not to be the user.

4. The information processing apparatus according to claim 1, wherein the second processor detects peeping by a person other than the user by detecting the person other than the person registered by the registration processing using the sensor.

5. The information processing apparatus according to claim 1, wherein, in a case where the person registered by the registration processing is no longer detected within the predetermined range, the second processor determines that the user has left even when a person(s) other than the registered person is detected within the predetermined range.

6. The information processing apparatus according to claim 5, wherein when determining that the user has left, the second processor limits use of at least some of functions of the OS.

7. The information processing apparatus according to claim 1, wherein the sensor is a radar sensor for detecting distance to and position of an object to be measured and present within the predetermined range.

8. The information processing apparatus according to claim 1, wherein the sensor is a camera for detecting distance to and position of an object to be measured and present within the predetermined range.

9. A control method for an information processing apparatus including: a memory which temporarily stores a program of an Operating System (OS); a first processor which executes processing based on the program of the OS stored in the memory; a display unit which displays display information according to processing based on the program of the OS; a sensor for detecting distance to and position of one or more persons present within a predetermined range in a direction to face a display surface of the display unit; and a second processor which executes processing based on detection results of the sensor, the control method comprising:
a step of causing the first processor to perform user authentication processing for determining whether or not to allow use of at least some of functions of the OS; and
a step of causing the second processor to register the position of a person closest in distance among persons detected using the sensor at timing when the use is determined to be allowed by the user authentication processing.
